(19) United States
(12) Patent Application Publication
(10) Pub. No.: US 2021/0278840 A1
(43) Pub. Date: Sep. 9, 2021

(54) AUTONOMOUS VEHICLE AND CONTROL METHOD THEREOF

(71) Applicant: LG ELECTRONICS INC., Seoul (KR)

(72) Inventor: Chan JAEGAL, Seoul (KR)

(73) Assignee: LG ELECTRONICS INC., Seoul (KR)

(21) Appl. No.: 16/486,651

(22) PCT Filed: Jun. 4, 2019
(86) PCT No.: PCT/KR2019/006755

§ 371 Date: Aug. 16, 2019

(51) Int. Cl. G05D 1/00; G05D 1/02; B60W 10/04; B60W 10/20; B60W 60/00; B60W 40/02; B60W 40/09; B60W 40/105

(52) U.S. Cl. CPC G05D 1/0088; B60W 2420/40; G05D 1/0257; G05D 1/0255; G05D 1/0242; B60W 10/04; B60W 10/20; B60W 60/001; B60W 40/02; B60W 40/09; B60W 40/105; B60W 2554/801; B60W 2554/802; B60W 2520/10; B60W 2520/12; B60W 2540/30; B60W 2420/42; B60W 2420/52; B60W 2420/54; G05D 1/0238

(57) ABSTRACT

An autonomous vehicle and control method thereof are disclosed. The autonomous vehicle of the present invention includes: an object detection unit that measures a sensing distance using one or more of a camera, a radar, a lidar, an ultrasonic sensor, and an infrared sensor; an autonomous module that determines a real-time sensing-based control range limited within the sensing distance, and reflects one or more of a learned propensity for driving of a user and a propensity for driving defined by external data received from an external device to driving control-related data of the vehicle; and a vehicle driving unit that drives the vehicle that is driven in an autonomous mode in accordance with the driving control-related data. One or more of an autonomous vehicle, an AI device, and an external device may be associated with an artificial intelligence module, a drone ((Unmanned Aerial Vehicle, UAV), a robot, an AR (Augmented Reality) device, a VR (Virtual Reality) device, a device associated with 5G services, etc.

### TECHNICAL FIELD

The present invention relates to an autonomous vehicle and a control method thereof and, more particularly, to an autonomous vehicle that controls autonomous driving by reflecting the propensity for driving of a user, and a method of controlling the autonomous vehicle.

### BACKGROUND ART

A vehicle is one of transportation that carries users in the vehicle in a desired direction and a car can be representatively exemplified. Vehicles provide convenience for moving to users, but it is required to carefully look at the front area and the rear area while driving. The front area and the rear area may mean driving interference factors such as an object, that is, a person, a vehicle, and an obstacle that approach or are positioned around a vehicle.

An autonomous vehicle can drive by itself without intervention of a driver. Many companies have already gone into the autonomous vehicle business and are absorbed in research and development.

### DISCLOSURE

### Technical Problem

An object of the present invention is to solve the necessities and/or problems described above.

Another object of the present invention is to reflect the propensity for driving of a user to autonomous driving control.

### Technical Solution

A autonomous vehicle of according to an aspect of the present invention includes: an object detection unit that measures a sensing distance using one or more of a camera, a radar, a lidar, an ultrasonic sensor, and an infrared sensor; an autonomous module that determines a real-time sensing-based control range limited within the sensing distance, and reflects one or more of a learned propensity for driving of a user and a propensity for driving defined by external data received from an external device to driving control-related data of the vehicle; and a vehicle driving unit that drives the vehicle that is driven in an autonomous mode in accordance with the driving control-related data.

A method of controlling the autonomous vehicle includes: measuring a sensing distance using one or more of a camera, a radar, a lidar, an ultrasonic sensor, and an infrared sensor; determining a real-time sensing-based control range limited within the sensing distance; reflecting one or more of a learned propensity for driving of a user and a propensity for driving defined by external data received from an external device to driving control-related data of the vehicle; and driving the vehicle that is driven in an autonomous mode in accordance with the driving control-related data.

### Advantageous Effects

Effects of the autonomous vehicle and a method of controlling the autonomous vehicle according to the present invention are as follows.

The present invention reflects the propensity for driving of a user (or driver) to an autonomous driving control on the basis of a learning result in a control range that secures driving safety, so customizing of autonomous driving control is possible, thereby being able to satisfaction of a user. Since the autonomous vehicle performs autonomous driving by itself by applying a manual driving propensity, a user can feel driving as if the autonomous vehicle drives in accordance with the user's driving intention.

The present invention reflect external data that secures stability and reliability and from which a propensity for driving can be selected to autonomous driving control, whereby it is possible to satisfaction of each user in autonomous driving.

Due to autonomous driving to which the propensity or habit for driving of a user is reflected within a control range in which driving safety is secured, the user can feel safe, and more dynamic or more comfortable driving in autonomous driving.

The effects of the present invention are not limited to the effects described above and other effects can be clearly understood by those skilled in the art from the following description.

### DESCRIPTION OF DRAWINGS

FIG. 1 is a block diagram of a wireless communication system to which methods proposed in the disclosure are applicable.

FIG. 2 is a diagram showing an example of a signal transmission/reception method in a wireless communication system.

FIG. 3 shows an example of basic operations of a user equipment and a 5G network in a 5G communication system.

FIG. 4 is a diagram showing a vehicle according to an embodiment of the present invention.

FIG. 5 is a block diagram of an AI device according to an embodiment of the present invention.

FIG. 6 is a diagram for illustrating a system in which an autonomous vehicle and an AI device according to an embodiment of the present invention are linked.

FIG. 7 is a flowchart showing a vehicle control method according to an embodiment of the present invention.

FIG. 8 is a flowchart showing a vehicle control method in which the propensity for driving of a user has been reflected to control of autonomous driving.

FIG. 9 is a flowchart showing vehicle control in which external data have been reflected to control of autonomous driving.

FIG. 10 is a flowchart showing a method of reflecting the propensity for driving of a user to autonomous driving control within a real-time sensing-based control range.

FIG. 11 is a flowchart showing a method of reflecting external data within a real-time sensing-based control range.

FIGS. 12 and 13 are diagrams showing driving control-related data to which the propensity for driving of a user or external data have been reflected in an autonomous mode.

### MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Hereafter, 5G communication (5th generation mobile communication) that a device and/or an AI processor, which requires AI-processed information, requires is described through a paragraph A to a paragraph G.

A. Example of Block Diagram of UE and 5G Network

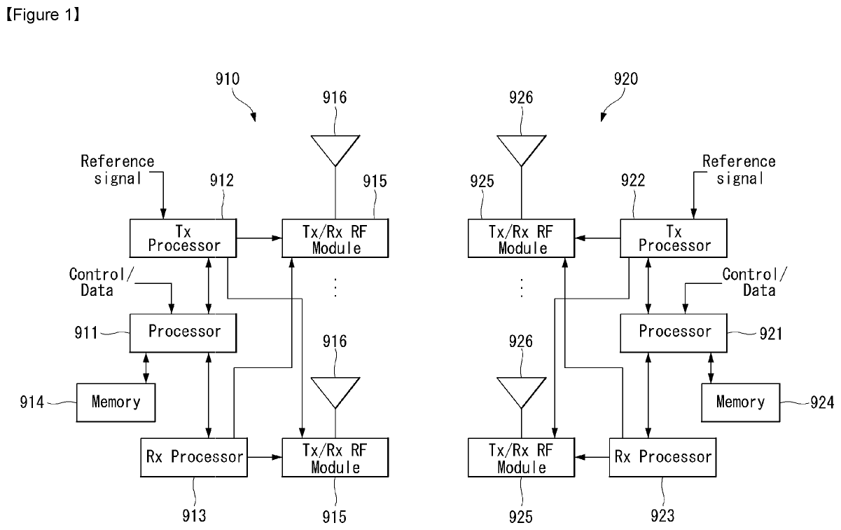

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operations.

A 5G network including another device communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

According to an embodiment of the present invention, the first communication device may be a vehicle and the second communication device may be a 5G network.

B. Signal Transmission/Reception Method in Wireless Communication System

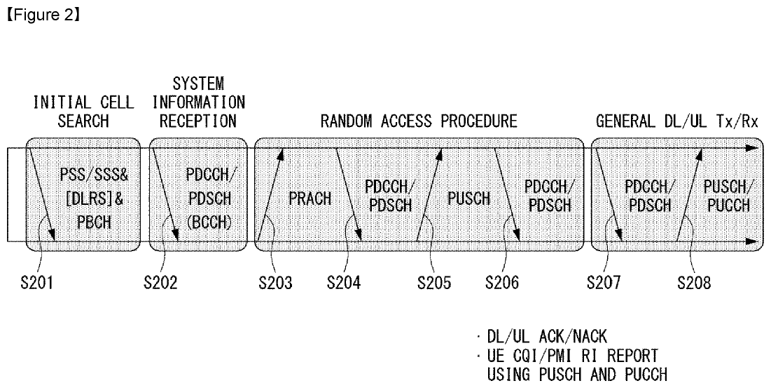

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.

A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.

The UE receives the signals on SSB resources from the BS on the basis of the CSI-SSB-ResourceSetList.

When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.

The UE receives an NZP CSI-RS resource set IE including an RRC parameter with respect to ‘repetition’ from a BS through RRC signaling. Here, the RRC parameter ‘repetition’ is set to ‘ON’.

The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.

The UE determines an RX beam thereof.

The UE skips a CSI report. That is, the UE can skip a CSI report when the RRC parameter ‘repetition’ is set to ‘ON’.

Next, the Tx beam determination procedure of a BS will be described.

The UE receives an NZP CSI-RS resource set IE including an RRC parameter with respect to ‘repetition’ from a BS through RRC signaling. Here, the RRC parameter ‘repetition’ is related to the Tx beam swiping procedure of the BS when set to ‘OFF’.

The UE receives signals on resources in a CSI-RS resource set in which the RRC parameter ‘repetition’ is set to ‘OFF’ in different DL spatial domain transmission filters of the BS.

The UE selects (or determines) a best beam.

The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.

A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.

When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCl by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation of AI Using 5G Communication

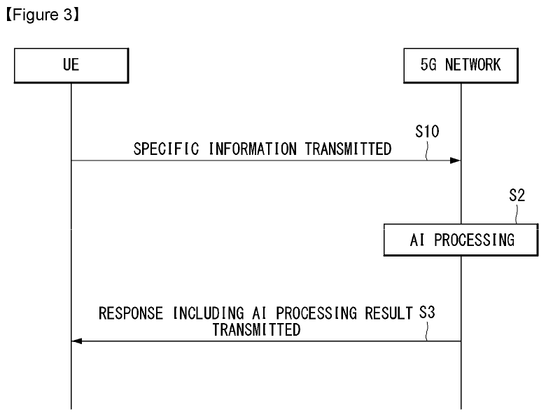

FIG. 3 shows an example of fundamental operations of a user equipment and a 5G network in a 5G communication system.

A UE transmits specific information to the 5G network (S1). In addition, the 5G network performs 5G processing for the specific information (S2). Here, the 5G processing may include AI processing. In addition, the 5G network transmit a response including an AI processing result to the UE (S3).

G. Applied Operations Between User Terminal and 5G Network in 5G Communication System

Hereinafter, an AI operation using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the UE performs an initial access procedure and a random access procedure with the 5G network prior to step S1 of FIG. 3 in order to transmit/receive signals, information and the like to/from the 5G network.

More specifically, the UE performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the UE performs a random access procedure with the 5G network for UL synchronization acquisition and/or UL transmission. The 5G network can transmit, to the UE, a UL grant for scheduling transmission of specific information. Accordingly, the UE transmits the specific information to the 5G network on the basis of the UL grant. In addition, the 5G network transmits, to the UE, a DL grant for scheduling transmission of 5G processing results with respect to the specific information. Accordingly, the 5G network can transmit a response including the AI processing result to the UE on the basis of the DL grant.

Next, a basic procedure of an applied operation to which a method proposed by the present invention which will be described later and URLLC of 5G communication are applied will be described.

As described above, a UE can receive DownlinkPreemption IE from the 5G network after the UE performs an initial access procedure and/or a random access procedure with the 5G network Then, the UE receives DCI format 2_1 including a preemption indication from the 5G network on the basis of DownlinkPreemption IE. The UE does not perform (or expect or assume) reception of eMBB data in resources (PRBs and/or OFDM symbols) indicated by the preemption indication. Thereafter, when the UE needs to transmit specific information, the UE can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the UE receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the UE transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The 5G communication technology described above can be applied in combination with methods to be described and proposed below in the present invention, or can be a supplement for realizing or clarifying the technological features of the methods proposed in the present invention.

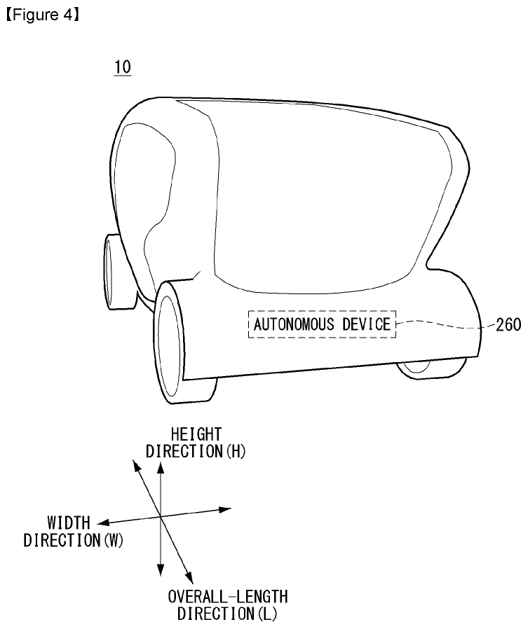

FIG. 4 is a diagram showing a vehicle according to an embodiment of the present invention.

Referring to FIG. 4, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

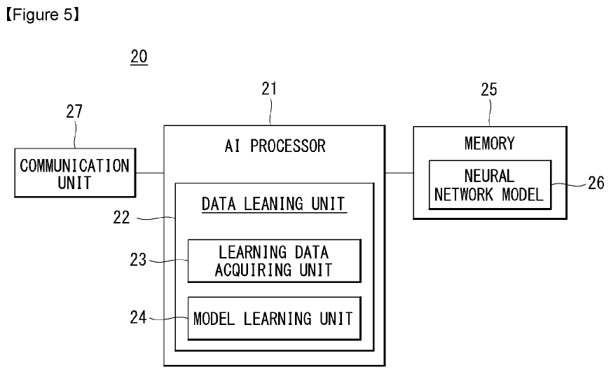

FIG. 5 is a block diagram of an AI device according to an embodiment of the present invention.

An AI device 20 may include an electronic device including an AI module that can perform AI processing, a server including the AI module, or the like. Further, the AI device 20 may be included as at least one component of the vehicle 10 shown in FIG. 4 to perform together at least a portion of the AI processing.

The AI processing may include all operations related to driving of the vehicle 10 shown in FIG. 4. For example, an autonomous vehicle can perform operations of processing/determining, and control signal generating by performing AI processing on sensing data or driver data. Further, for example, an autonomous vehicle can perform autonomous driving control by performing AI processing on data acquired through interaction with other electronic devices included in the vehicle.

The AI device 20 may include an AI processor 21, a memory 25, and/or a communication unit 27.

The AI device 20, which is a computing device that can learn a neural network, may be implemented as various electronic devices such as a server, a desktop PC, a notebook PC, and a tablet PC.

The AI processor 21 can learn a neural network using programs stored in the memory 25. In particular, the AI processor 21 can learn a neural network for recognizing data related to vehicles. Here, the neural network for recognizing data related to vehicles may be designed to simulate the brain structure of human on a computer and may include a plurality of network nodes having weights and simulating the neurons of human neural network. The plurality of network nodes can transmit and receive data in accordance with each connection relationship to simulate the synaptic activity of neurons in which neurons transmit and receive signals through synapses. Here, the neural network may include a deep learning model developed from a never network model. In the deep learning model, a plurality of network nodes is positioned in different layers and can transmit and receive data in accordance with a convolution connection relationship. The neural network, for example, includes various deep learning techniques such as deep neural networks (DNN), convolutional deep neural networks (CNN), recurrent neural networks (RNN), a restricted boltzmann machine (RBM), deep belief networks (DBN), and a deep Q-network, and can be applied to fields such as computer vision, voice recognition, natural language processing, and voice/signal processing.

Meanwhile, a processor that performs the functions described above may be a general purpose processor (e.g., a CPU), but may be an AI-only processor (e.g., a GPU) for artificial intelligence leaning.

The memory 25 can store various programs and data for the operation of the AI device 20. The memory 25 may be a nonvolatile memory, a volatile memory, a flash-memory, a hard disk drive (HDD), a solid state drive (SDD), or the like. The memory 25 is accessed by the AI processor 21 and reading-out/recording/correcting/deleting/updating, etc. of data by the AI processor 21 can be performed. Further, the memory 25 can store a neural network model (e.g., a deep learning model 26) generated through a learning algorithm for data classification/recognition according to an embodiment of the present invention.

Meanwhile, the AI processor 21 may include a data learning unit 22 that learns a neural network for data classification/recognition. The data learning unit 22 can learn references about what learning data are used and how to classify and recognize data using the learning data in order to determine data classification/recognition. The data learning unit 22 can learn a deep learning model by acquiring learning data to be used for learning and applying the acquired learning data to the deep learning model.

The data learning unit 22 may be manufactured in the type of at least one hardware chip and mounted on the AI device 20. For example, the data learning unit 22 may be manufactured in a hardware chip type only for artificial intelligence, and may be manufactured as a part of a general purpose processor (CPU) or a graphics processing unit (GPU) and mounted on the AI device 20. Further, the data learning unit 22 may be implemented as a software module. When the software module is implemented as a software module (or a program module including instructions), the software module may be stored in non-transitory computer readable media that can be read through a computer. In this case, at least one software module may be provided by an OS (operating system) or may be provided by an application.

The data learning unit 22 may include a learning data acquiring unit 23 and a model learning unit 24.

The learning data acquiring unit 23 can acquire learning data required for a neural network model for classifying and recognizing data. For example, the learning data acquiring unit 23 can acquire, as learning data, vehicle data and/or sample data to be input to a neural model.

The model learning unit 24 can perform learning such that a neural network model has a determination reference about how to classify predetermined data, using the acquired learning data. In this case, the model learning unit 24 can train a neural network model through supervised learning that uses at least some of learning data as a determination reference. Alternatively, the model learning data 24 can train a neural network model through unsupervised learning that finds out a determination reference by performing learning by itself using learning data without a map. Further, the model learning unit 24 can train a neural network model through reinforcement learning using feedback about whether the result of situation determination according to learning is correct. Further, the model learning unit 24 can train a neural network model using a learning algorithm including error back-propagation or gradient decent.

When a neural network model is learned, the model learning unit 24 can store the learned neural network model in the memory. The model learning unit 24 may store the learned neural network model in the memory of a server connected with the AI device 20 through a wire or wireless network.

The data learning unit 22 may further include a learning data preprocessor (not shown) and a learning data selector (not shown) to improve the analysis result of a recognition model or reduce resources or time for generating a recognition model.

The learning data preprocessor can preprocess acquired data such that the acquired data can be used in learning for situation determination. For example, the learning data preprocessor can process acquired data in a predetermined format such that the model learning unit 24 can use learning data acquired for learning for image recognition.

Further, the learning data selector can select data for learning from the learning data acquired by the learning data acquiring unit 23 or the learning data preprocessed by the preprocessing unit. The selected learning data can be provided to the model learning unit 24. For example, the learning data selector can select only data for objects included in a specific area as learning data by detecting the specific area in an image acquired through a camera of a vehicle.

Further, the data learning unit 22 may further include a model estimator (not shown) to improve the analysis result of a neural network model.

The model estimator inputs estimation data to a neural network model, and when an analysis result output from the estimation data does not satisfy a predetermined reference, it can make the model learning unit 22 perform learning again. In this case, the estimation data may be data defined in advance for estimating a recognition model. For example, when the number or ratio of estimation data with an incorrect analysis result of the analysis result of a recognition model learned with respect to estimation data exceeds a predetermined threshold, the model estimator can estimate that a predetermined reference is not satisfied.

The communication unit 27 can transmit the AI processing result by the AI processor 21 to an external electronic device.

Here, the external electronic device may be defined as an autonomous vehicle. Further, the AI device 20 may be defined as another vehicle or a 5G network that communicates with the autonomous vehicle. Meanwhile, the AI device 20 may be implemented by being functionally embedded in an autonomous module included in a vehicle. Further, the 5G network may include a server or a module that performs controlled related to autonomous driving.

Meanwhile, the AI device 20 shown in FIG. 5 was functionally separately described into the AI processor 21, the memory 25, the communication unit 27, etc., but it should be noted that the aforementioned components may be integrated in one module and referred to as an AI module.

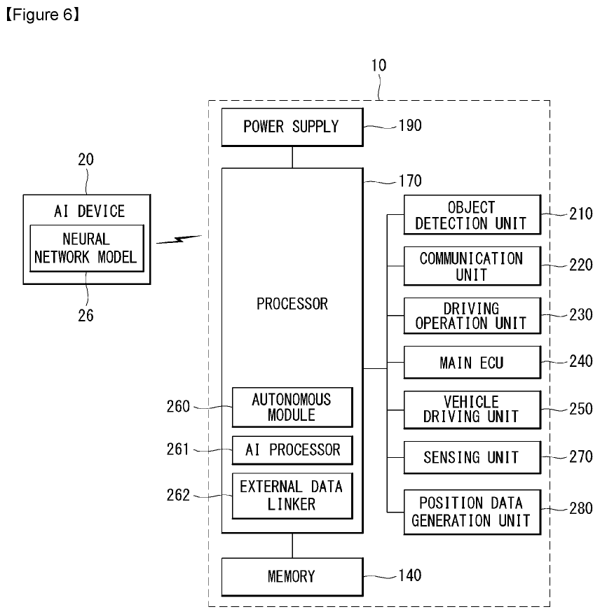

FIG. 6 is a diagram for illustrating a system in which an autonomous vehicle and an AI device according to an embodiment of the present invention are linked.

Referring to FIG. 6, an autonomous vehicle 10 can transmit data that requires AI processing to an AI device 20 through a communication unit and the AI device including a neural network model 26 can transmit an AI processing result using the neural network model 26 to the autonomous vehicle 10. The description of FIG. 2 can be referred to for the AI device 20.

The autonomous vehicle 10 may include a memory 140, a processor 170, and a power supply 170 and the processor 170 may further include an autonomous module 260 and an AI processor 261. Further, the autonomous vehicle 10 may include an interface that is connected with at least one electronic device included in the vehicle in a wired or wireless manner and can exchange data for autonomous driving control. At least one electronic device connected through the interface may include an object detection unit 210, a communication unit 220, a driving operation unit 230, a main ECU 240, a vehicle driving unit 250, a sensing unit 270, and a position data generation unit 280.

The interface can be configured using at least one of a communication module, a terminal, a pin, a cable, a port, a circuit, an element, and a device.

The memory 140 is electrically connected with the processor 170. The memory 140 can store basic data about units, control data for operation control of units, and input/output data. The memory 140 can store data processed in the processor 170. Hardware-wise, the memory 140 may be configured using at least one of a ROM, a RAM, an EPROM, a flash drive and a hard drive. The memory 140 can store various types of data for the overall operation of the autonomous vehicle 10, such as a program for processing or control of the processor 170. The memory 140 may be integrated with the processor 170. Depending on embodiments, the memory 140 may be classified as a lower configuration of the processor 170.

The power supply 190 can supply power to the autonomous vehicle 10. The power supply 190 can be provided with power from a power source (e.g., a battery) included in the autonomous vehicle 10 and can supply the power to each unit of the autonomous vehicle 10. The power supply 190 can operate according to a control signal supplied from the main ECU 140. The power supply 190 may include a switched-mode power supply (SMPS).

The processor 170 can be electrically connected to the memory 140, the interface 180, and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal, and provide the signal while power is supplied thereto.

The processor 170 can receive information from other electronic devices included in the autonomous vehicle 10 through the interface. The processor 170 can provide control signals to other electronic devices in the autonomous vehicle 10 through the interface.

The autonomous device 10 may include at least one printed circuit board (PCB). The memory 140, the interface, the power supply 190, and the processor 170 may be electrically connected to the PCB.

Hereafter, other electronic devices connected with the interface and included in the vehicle, the AI processor 261, and the autonomous module 260 will be described in more detail. Hereafter, for the convenience of description, the autonomous vehicle 10 is referred to as a vehicle 10.

First, the object detection unit 210 can generate information on objects outside the vehicle 10. The AI processor 261 can generate at least one of on presence or absence of an object, positional information of the object, information on a distance between the vehicle and the object, and information on a relative speed of the vehicle with respect to the object by applying data acquired through the object detection unit 210 to a neural network model.

The object detection unit 210 may include at least one sensor that can detect objects outside the vehicle 10. The sensor may include a camera, a radar, a lidar, an ultrasonic sensor, and an infrared sensor. The object detection unit 210 can provide data about an object generated on the basis of a sensing signal generated from a sensor to at least one electronic device included in the vehicle.

Meanwhile, the vehicle 10 transmits the data acquired through at least one sensor to the AI device 20 through the communication unit 220 and the AI device 20 can transmit the generated AI processing data to the vehicle 10 by applying the neural network model 26 to the transmitted data. The vehicle 10 recognizes information about the detected object on the basis of the received processing data and the autonomous module 260 can perform an autonomous driving control operation using the recognized information.

The communication unit 220 can exchange signals with devices disposed outside the vehicle 10. The communication unit 220 can exchange signals with at least one of an infrastructure (e.g., a server and a broadcast station), another vehicle, and a terminal. The communication unit 220 may include a transmission antenna, a reception antenna, and at least one of a radio frequency (RF) circuit and an RF element which can implement various communication protocols in order to perform communication.

It is possible to generate at least one of on presence or absence of an object, positional information of the object, information on a distance between the vehicle and the object, and information on a relative speed of the vehicle with respect to the object by applying data acquired through the object detection unit 210 to a neural network model.

The driving operation unit 230 is a device for receiving user input for driving. In a manual mode, the vehicle 10 may be driven on the basis of a signal provided by the driving operation unit 230. The driving operation unit 230 may include a steering input device (e.g., a steering wheel), an acceleration input device (e.g., an acceleration pedal) and a brake input device (e.g., a brake pedal).

Meanwhile, the AI processor 261, in an autonomous mode, can generate an input signal of the driving operation unit 230 in accordance with a signal for controlling movement of the vehicle according to a driving plan generated through the autonomous module 260.

Meanwhile, the vehicle 10 transmits data for controlling the driving operation unit 230 to the AI device 20 through the communication unit 220 and the AI device 20 can transmit the generated AI processing data to the vehicle 10 by applying the neural network model 26 to the transmitted data. The vehicle 10 can use the input signal of the driving operation unit 230 to control movement of the vehicle on the basis of the received AI processing data.

The main ECU 240 can control the overall operation of at least one electronic device included in the vehicle 10.

The vehicle driving unit 250 is a device for electrically controlling various vehicle driving devices included in the vehicle 10. The vehicle driving unit 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device, and a suspension driving control device. Meanwhile, the safety device driving control device may include a seat belt driving control device for seat belt control.

The vehicle driving unit 250 includes at least one electronic control device (e.g., a control ECU (Electronic Control Unit)).

The vehicle driving unit 250 can control a power train, a steering device, and a brake device on the basis of signals received by the autonomous module 260. The signals received by the autonomous module 260 may be driving control signals that are generated by applying a neural network model to data related to the vehicle in the AI processor 261. The driving control signals may be signals received from the external AI device 20 through the communication unit 220.

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor, and a magnetic sensor.

The AI processor 261 can generate state data of the vehicle by applying a neural network model to sensing data generated by at least one sensor. The AI processing data generated by applying the neural network model may include vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake pedal, etc.

The autonomous module 260 can generate a driving control signal on the basis of the AI-processed state data of the vehicle.

Meanwhile, the vehicle 10 transmits the sensing data acquired through at least one sensor to the AI device 20 through the communication unit 22 and the AI device 20 can transmit the generated AI processing data to the vehicle 10 by applying the neural network model 26 to the transmitted sensing data.

The position data generation unit 280 can generate position data of the vehicle 10. The position data generation unit 280 may include at least one of a global positioning system (GPS) and a differential global positioning system (DGPS).

The AI processor 261 can generate more accurate position data of the vehicle by applying a neural network model to position data generated by at least one position data generation device.

In accordance with an embodiment, the AI processor 261 can perform deep learning calculation on the basis of at least any one of the internal measurement unit (IMU) of the sensing unit 270 and the camera image of the object detection unit 210 and can correct position data on the basis of the generated AI processing data.

Meanwhile, the vehicle 10 transmits the position data acquired from the position data generation unit 280 to the AI device 20 through the communication unit 220 and the AI device 20 can transmit the generated AI processing data to the vehicle 10 by applying the neural network model 26 to the received position data.

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

The autonomous module 260 can generate a route for autonomous driving and a driving plan for driving along the generated route on the basis of the acquired data.

The autonomous module 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The AI processor 261 can transmit control signals that can perform at least one of the ADAS functions described above to the autonomous module 260 by applying traffic-related information received from at least one sensor included in the vehicle and external devices and information received from another vehicle communicating with the vehicle to a neural network model.

Further, the vehicle 10 transmits at least one data for performing the ADAS functions to the AI device 20 through the communication unit 220 and the AI device 20 can transmit the control signal that can perform the ADAS functions to the vehicle 10 by applying the neural network model 260 to the received data.

The autonomous module 260 can acquire state information of a driver and/or state information of a vehicle through the AI processor 261 and can perform switching from an autonomous mode to a manual driving mode or switching from the manual driving mode to the autonomous mode.

The object detection unit 210 measures a sensing distance of the vehicle 10 by analyzing a sensor signal output from one or more of a camera, a radar, a lidar, an ultrasonic sensor, and an infrared sensor. The sensing distance is a maximum sensing distance at which an object can be detected. The sensing distance may be different in accordance with sensing performance, landmarks around a driving route, a road section, weather, time, traffic complexity, etc. Accordingly, in autonomous driving, the sensing distance may change in accordance with driving environments.

The autonomous module 260 can control the vehicle driving unit 250 during autonomous driving by reflecting the learned propensity for driving of a user or external data within a control range limited within the sensing distance measured by the object detection unit 210. The vehicle driving unit 250 drives the vehicle that is driven in the autonomous mode in accordance with driving control-related data input from the autonomous module 260. The vehicle driving unit 250 can adjust deceleration/acceleration and steering on the basis of the driving control-related data.

The propensity for driving may be defined as propensity (or habit) for driving that a user feels comfortable in or prefers.

In general, safety and fastness are in inverse proportion in vehicle driving. Considering this, propensity for driving can be classified into Safety that gives top priority to safety, Comport that reflects normal propensity for driving, Dynamic that give priority to fastness, etc., but is not limited thereto.

A user may be a driver in the manual driving mode. When the driver manually drives the vehicle 10 by directly operating the vehicle 10 in the manual driving mode, driver data such as the average speed, the maximum speed, the deceleration/acceleration control level, the inter-vehicle distance, the angular speed, and the lane change frequency of the vehicle 10 can be collected and learned by the AI processor 261. In FIG. 3, specific information may include driver data related to the propensity for driving of a user or propensity for driving of external data.

The AI processor 20 can determine the propensity for driving of a user by learning the driver data collected in the manual driving mode.

The autonomous module 260 can change driving control-related data by controlling the vehicle driving unit 250 in accordance with the learned propensity for driving of a user or external data.

The driving control-related data may include one or more of the average speed, the maximum speed, the deceleration/acceleration control level, the inter-vehicle distance, the angular speed, and the lane change frequency of the vehicle 10. The driving control-related data may control all the average speed, the maximum speed, the deceleration/acceleration control level, the inter-vehicle distance, the angular speed, and the lane change frequency of the vehicle 10.

The autonomous module 260 controls the vehicle driving unit 250 within the sensing distance at which an object can be recognized in order to secure driving safety. Hereafter, the driving control range of the vehicle 10 that is limited within the sensing distance is referred to as a “real-time sensing-based control range”. The real-time sensing-based control range is a safety range that limits the control range of the vehicle 10 to secure safety of the vehicle is autonomous driving.

The autonomous module 260 can control the vehicle driving unit 250 on the basis of the learned driving propensity data of a user received from the AI processor 261 or external data received from a server through a network.

An external data linker 262 transmits external data received from an external device to the autonomous module 260.

The external data linker 262 can receive driver data, which are collected from other drivers, from a server and can transmit the driver data to the AI processor 261. The server may include the AI device 20. In this case, the AI processor 261 can generate and provide external data to the autonomous module 260 on the basis of the driver data collected from other drivers.

Meanwhile, the vehicle 10 can use AI processing data for passenger support for driving control. For example, as described above, it is possible to check the states of a driver and passengers through at least one sensor included in the vehicle.

Alternatively, the vehicle 10 can recognize voice signals of a driver or passengers, perform a voice processing operation, and perform a voice synthesis operation through the AI processor 261.

5G communication for implementing the vehicle control method according to an embodiment of the present invention and schematic contents for performing AI processing by applying the 5G communication and for transmitting/receiving the AI processing result were described above.

Hereafter, a method of controlling autonomous driving on the basis of learned propensity for driving of a user or external data in accordance with an embodiment of the present invention will be described in detail in association with drawings.

The autonomous module 260 basically processes and determines the driving state of a vehicle in real time in response to a sensor signal of the object detection unit 210. The autonomous module 260 can control the driving state of the vehicle by inputting driving control-related data to the main ECU 240 and the vehicle driving unit 250.

The autonomous module 260 can reflect the propensity for driving of a user to control of the vehicle in autonomous driving on the basis of the propensity for driving of the driver who drives the vehicle 10 in a manual mode or external data in which representative values of various propensities for driving are set.

The external data can be received to the vehicle 10 from external devices such as an application programming interface (API) and a cloud server connected through a network of a vehicle manufacturer or an autonomous driving service provider. The external data can be displayed in a UI image that is displayed on a display of the vehicle 10. The user can select a propensity for driving that he/she prefers from the propensities for driving defined in the external data displayed on the display of the vehicle 10 in the autonomous mode. The user can download the external data on the UI image and can perform updating.

The UI image can show the propensities for driving of the external data through a term and menu configuration that the user easily understands. The UI image can show direct values of driving control-related data in an expert mode so that the user can finely adjust the data values. The higher the selection frequency of a specific propensity for driving selected by the user, the higher weight the UI can apply to the propensity for driving.

The autonomous module 260 can determine the driving control range of the vehicle on the basis of a real-time sensing result that can secure safety of the vehicle 10 for the current driving route, section, and situation. When the propensity for driving of a user or external data is reflected to the driving control-related data in the autonomous mode, the autonomous module 260 controls the vehicle 10 within the control range that secures driving safety by reflecting the propensity for driving of the user and the external data only within the real-time sensing-based control range. For example, when the autonomous module 260 reflects the propensity for driving of a user or external data to the driving control-related data, the autonomous module 260 can limit the propensity or the external data to the maximum value in the control range if the control range is exceeded.

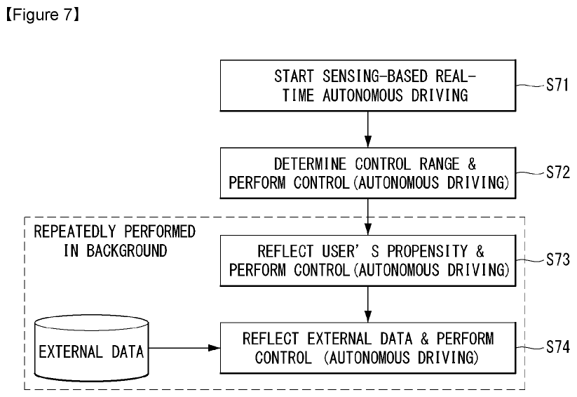

FIG. 7 is a flowchart of a vehicle control method according to an embodiment of the present invention.

Referring to FIG. 7, the vehicle 10 can be driven in the autonomous mode on the basis of a real-time sensing result (S71).

The autonomous module 260 controls autonomous driving by determining the real-time sensing-based control range on the basis of the real-time sensing result received from the object detection unit 210 (S72). The real-time sensing-based control range may be changed in accordance with the sensor performance of the vehicle 10, the road situation, the configuration of the surrounding ground, weather, traffic complexity, etc.

The autonomous module 260 can adjust the driving control-related data by reflecting the learned propensity for driving of a user. The AI processor 261 can lean driver data collected in the manual driving mode. The driver data can determine the average speed, the maximum speed, the deceleration/acceleration control level, the inter-vehicle distance, the rotational speed and steering angle (angular speed), the lane change frequency, etc. of the vehicle 10 when the vehicle is manually driven.

The deceleration/acceleration control level can be determined from an idle speed (or idle rpm), on/off of an electronic stability program (ESP), etc. The idle speed is the rpm without a gear connected to an engine. In ESP-on, rapid acceleration of the vehicle 10 is suppressed and a rapid attitude change of the vehicle is suppressed while the vehicle is driven, so a user can feel stable driving. In ESP-off, acceleration of the vehicle 10 is increases, so a user can feel dynamic driving.

The AI processor 261 can learn the propensity (or habit) for controlling a vehicle while driving of each driver by learning driver data. The learned propensity for controlling a vehicle of each driver is applied to a leaned propensity for driving that is applied to the vehicle 10 when the vehicle 10 performs autonomous driving.

The autonomous module 260 recognizes a user in the vehicle 10 and reflects the learned propensity for driving of the user to autonomous driving control data when the vehicle 10 performs autonomous driving (S73).

The autonomous module 260 reflects external data received through a network to the autonomous driving control data when the vehicle 10 performs autonomous driving (S74).

The external data may include representative values of various propensities for driving that represent propensities for driving. Vehicle control values that are controlled by the external data are limited within a control range of the vehicle in which driving safety is secured in order to secure driving safety and reliability.

The external data may define one or more driving control data of the average speed, the maximum speed, the deceleration/acceleration control level, the inter-vehicle distance, the angular speed, and the lane change frequency of the vehicle 10 for each of predetermined propensities for driving. The external data may control all the average speed, the maximum speed, the deceleration/acceleration control level, the inter-vehicle distance, the angular speed, and the lane change frequency of the vehicle 10.

The external data can be generated in the following methods (1) and (2).

(1) External data can be obtained as data modeled in advance for each propensity for driving on the basis of pre-driving tests repeatedly performed by an expert driver or a company. The expert driver can be selected as a driver who can represent a propensity for driving. Accordingly, the external data can define driving control-related data that represent the propensities for driving. The propensities for driving defined in the external data can be divided into Safety, comfort, dynamic, etc.

(2) A representative value for each propensity for driving can be set on the basis of the average of driver data collected from one or more different drivers. In this case, the propensities (or habits) for driving of different drivers who respectively represent propensities for driving such as safety, comfort, and dynamic can be reflected to control of the vehicle 10 in autonomous driving.

Steps S73 and S74 can be selected by a user (or driver). The AI processor 261 can repeatedly process the steps S3 and S4 through background programming. The AI processor 261 can update the propensity for driving of a user in real time on the basis of the driver data learning result of the user himself/herself in the vehicle 10. The AI processor 261 can update the external data in real time by reflecting a learning result of driver data collected from another driver.

The driving propensity data of a user and the external data can be set for each driving road section in association with position data. For example, external data set to be appropriate for a corresponding section can be reflected to control of the vehicle 10 that performs autonomous driving in accordance with the section that the vehicle current passes in autonomous driving. Further, the driving propensity data of a user and the external data can correspond to various driving situations by being divided into weather, time, and traffic complexity. For example, the external data that is received to the vehicle 10 in a situation with bad weather or high traffic complexity may be data that has been multiplied by a stable driving control value as a weight. The stable driving control value may decrease the driving speed, increase the inter-vehicle distance, and decrease the land change frequency.

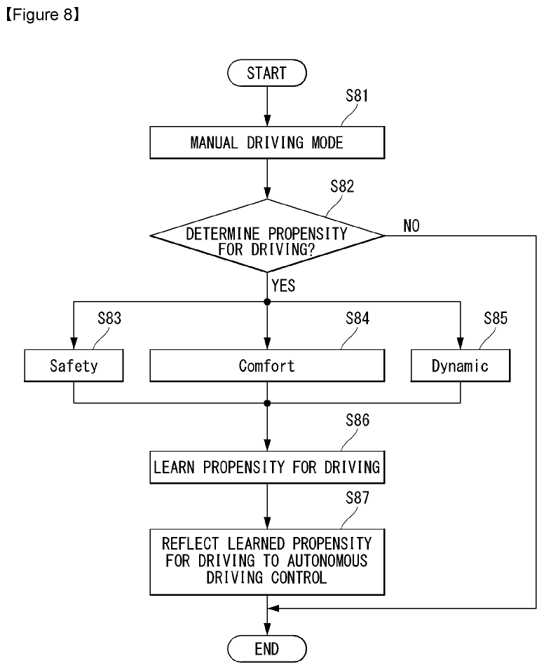

FIG. 8 is a flowchart showing a vehicle control method in which the propensity for driving of a user has been reflected to control of autonomous driving.

Referring to FIG. 8, the AI device 20 or the AI processor 261 determines the propensity for driving of the driver who drives the vehicle 10 is a manual driving mode (S81 and S82). The propensity for driving of the driver can be determined on the basis of the analysis result of the driving control-related data collected in the manual driving mode. The driving control-related data can determine the average speed, the maximum speed, the deceleration/acceleration control level, the inter-vehicle distance, the angular speed, the lane change frequency, etc. of the vehicle 10.

The AI device 20 or the AI processor 261 classifies the propensity for driving of each user collected in the manual driving mode into Safety, comfort, dynamic, etc. (S83, S84, and S85). The AI device 20 or the AI processor 261 leans the propensity for driving collected for each user (S86). The propensity for driving of each user can be learned separately on the basis of a road section, weather, time, traffic complexity, etc.

The autonomous module 260 reflects driving propensity data of users provided from the AI device 20 or the AI processor in an autonomous mode to the driving control-related data within a real-time sensing-based control range (S87).

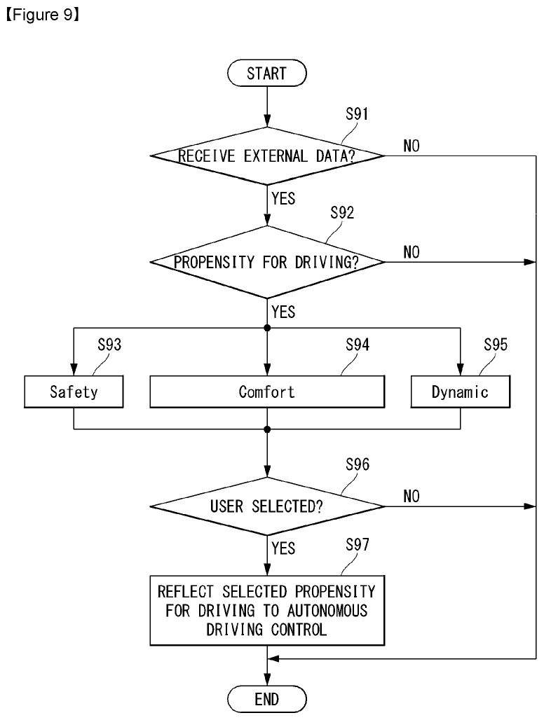

FIG. 9 is a flowchart showing vehicle control in which external data have been reflected to control of autonomous driving.

Referring to FIG. 9, the external data linker 262 receives external data (S91).

The autonomous module 260 shows propensities for driving classified in the external data on a display of the vehicle 10 by inputting the external data provided from the external data linker 262 to a UI program. The external data can define representative values of various propensities for driving such as Safety, comfort, and dynamic (S92 to S95).

When a user selects a propensity for driving that he/she prefers from an UI image showing the representative value of each propensity for driving of the external data, the autonomous module 260 reflects the propensity for driving of the external data selected by the user to the driving control-related data within the real-time sensing-based control range in the autonomous mode (S96 and S97).

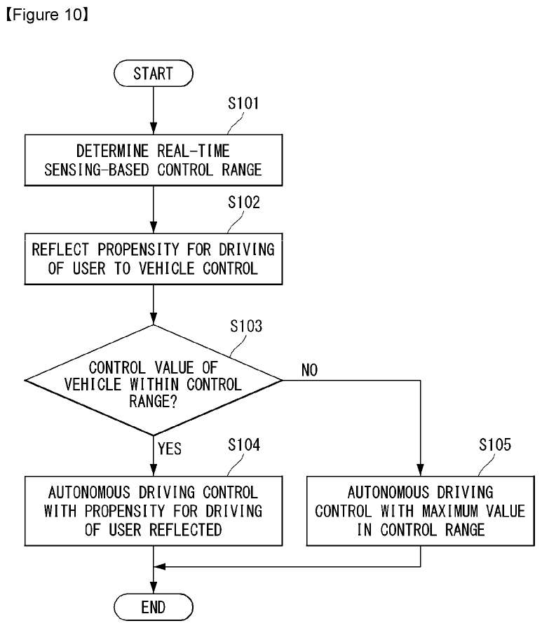

FIG. 10 is a flowchart showing a method of reflecting the propensity for driving of a user to autonomous driving control within a real-time sensing-based control range.

Referring to FIG. 10, the autonomous module 260 determines a real-time sensing-based control range that is limited within a sensing distance received from the object detection unit 210 (S101). The sensing distance of the vehicle 10 is changed in accordance with the sensor performance of the vehicle 10, the road situation, the configuration of the surrounding ground, weather, traffic complexity, etc., so the sensing distance can be changed during driving.

The autonomous module 260 reflects the propensity for driving of a user to control of the vehicle 10 in autonomous driving in the autonomous mode by applying the learned propensity for driving of a user to the driving control-related data of the vehicle in the autonomous mode (S102, S103, and S104).

The autonomous driving-related data to which the propensity for driving of a user has been reflected may exceed the real-time sensing-based control range. In this case, the autonomous module 260 can control the vehicle 10 at the maximum value of the real-time sensing-based control range for driving safety (S105).

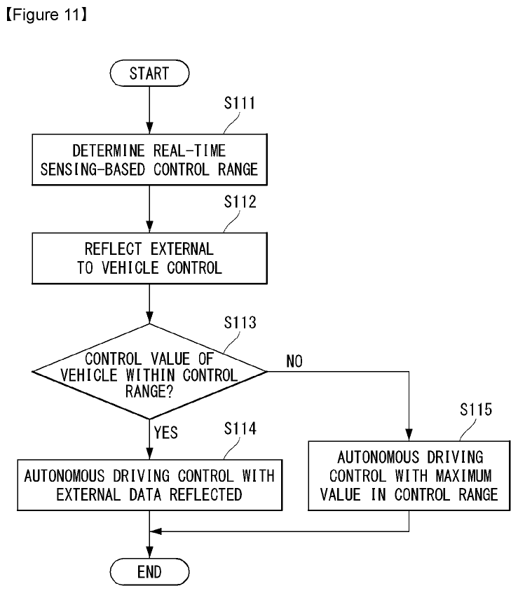

FIG. 11 is a flowchart showing a method of reflecting external data within a real-time sensing-based control range.

Referring to FIG. 11, the autonomous module 260 determines a real-time sensing-based control range that is limited within a sensing distance received from the object detection unit 210 (S111). The sensing distance of the vehicle 10 is changed in accordance with the sensor performance of the vehicle 10, the road situation, the configuration of the surrounding ground, weather, traffic complexity, etc., so the sensing distance can be changed during driving.

The autonomous module 260 reflects a propensity for driving selected by a user to control of the vehicle 10 in the autonomous mode by applying external data provided through the external data linker 62 to the driving control-related data in the autonomous mode (S112, S113, and S114).

The autonomous driving-related data to which the propensity for driving of the external data selected by a user has been reflected may exceed the real-time sensing-based control range. In this case, the autonomous module 260 can control the vehicle 10 at the maximum value of the real-time sensing-based control range for driving safety (S115).

The autonomous module 260 can reflect the propensity for driving of a user or external data to autonomous driving-related data in the following method.

The autonomous module 260 derives a real-time sensing-based range within the sensing distance of the vehicle 10. The autonomous module 260 reflects a propensity for driving that a driver prefers to vehicle control by reflecting the propensity for driving of a user or external data to the driving control-related data within the real-time sensing-based control range.

The driving control-related data can be calculated as a default value (or current value) that can secure driving safety+propensity for driving of a user (or external data). For example, an average speed can be calculated as the average value of the result of adding the propensity for driving of a user to a basic speed. When the basic speed is 40 km/h and the speed according to the propensity for driving of a user (or external data) is 45 km/h, the average speed to which the propensity for driving of a user has been reflected can be calculated as 40 km/h+45 km/h)/2=42.5 km/h.

The autonomous module 260 can reflect a propensity for driving that a driver prefers to vehicle control by reflecting the propensity for driving of a user and external data to the driving control-related data within the real-time sensing-based control range. In this case, the propensity for driving of a user can be applied first, but is not limited thereto. The user can select any one of the propensity for driving of the user and the external data on a UI image or can apply both of them and adjust the application ratio.

When both of the propensity for driving of a user and the external data are reflected to vehicle control in autonomous driving, the average speed can be calculated as in the following example.

average speed=value obtained by reflecting propensity for driving of user to basic speed+external data=(42.5 km/h+55 km/h)/2=48.75 km/h (where 55 km is the average speed of the external data).

When a specific propensity for driving of the external data is repeatedly applied to vehicle control in autonomous driving, the autonomous module 260 can increase the weight of the external data as in the following examples. The AI processor 261 can change the weight by analyzing the application frequency of the external data.

average speed=value obtained by reflecting propensity for driving of user to basic speed+(external data*weight of 10%)=42.5 km/h+(55 km/h×1.1)/2=51.5 km/h

average speed=value obtained by reflecting propensity for driving of user to basic speed+(external data*weight of 20%)=42.5 km/h+(55 km/h×1.2)/2=54.25 km/h

average speed=value obtained by reflecting propensity for driving of user to basic speed+(external data*weight of 30%)=42.5 km/h+(55 km/h×1.3)/2=57 km/h

The average speed to which the propensity for driving of a user and/or external data have been reflected may exceed the maximum average speed defined by the real-time sensing-based control range. In this case, the autonomous module 260 limits the average speed to which the propensity for driving of a user and/or external data have been reflected to the maximum average speed defined by the real-time sensing-based control range. For example, when the maximum average speed defined by the real-time sensing-based control range is 55 km/h, 57 km/h is adjusted to 55 km/h in the above examples.

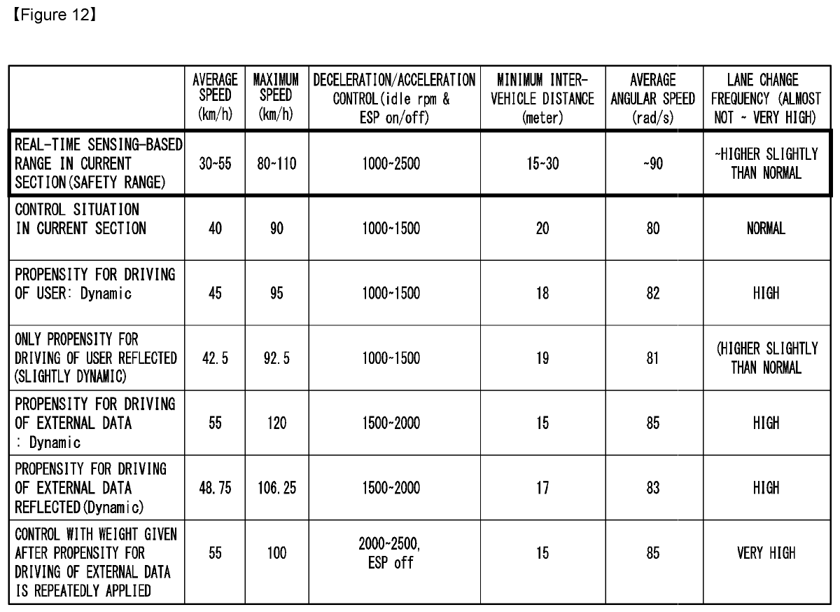

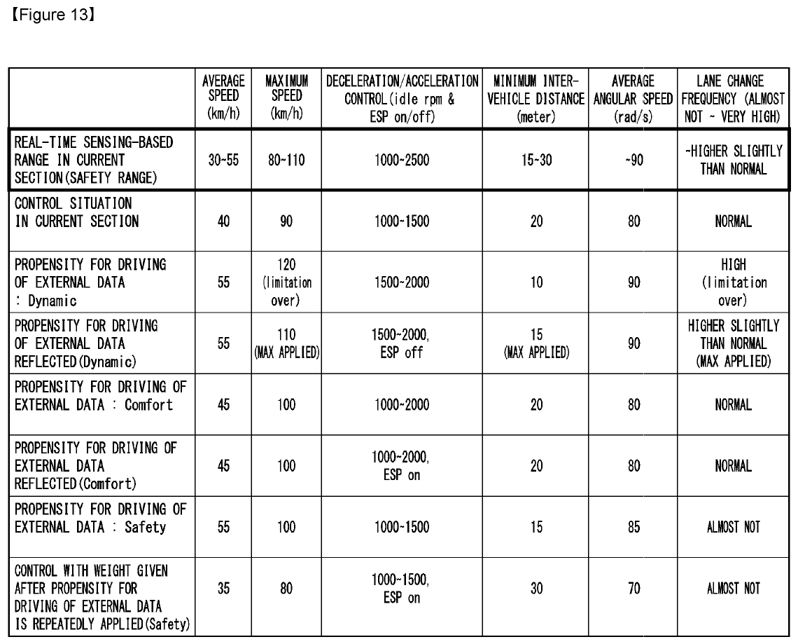

FIGS. 12 and 13 are diagrams showing driving control-related data to which the propensity for driving of a user or external data have been reflected in an autonomous mode. FIG. 12 is an example in which the propensity for driving of a user has been reflected first to vehicle control in autonomous driving. FIG. 13 is an example in which when a user has selected a propensity for driving defined in external data and the external data have been reflected to vehicle control in autonomous driving.

Referring to FIG. 12, the real-time sensing-based control range (safety range) in the current section in autonomous driving may be defined to be average speed 30˜55 km/h, maximum speed 80˜110 km/h, deceleration/acceleration control of 1000˜2500 rpm and ESP-on, minimum inter-vehicle distance=15˜30 m, average angular speed=˜90 rad/sec, lane change frequency: slightly higher than normal, etc.

An example with average speed=40 km/h, maximum speed=90 km/h, deceleration/acceleration control of 1000˜1500 rpm and ESP-on, minimum inter-vehicle distance=20 m, average angular speed=80 rad/sec, and lane change frequency: normal is assumed as driving control-related data according to a vehicle control situation in the current section.

When the learned propensity for driving of a user is dynamic, the driving control-related data of the propensity for driving of a user may be average speed=45 km/h, maximum speed=95 km/h, deceleration/acceleration control of 1000˜1500 rpm and ESP-on, minimum inter-vehicle distance=18 m, average angular speed=80 rad/sec, and lane change frequency: high. When the propensity for driving of a user is applied to a default value, that is, the current value, the driving control-related data can be adjusted to be average speed=42.5 km/h, maximum speed=92.5 km/h, deceleration/acceleration control of 1000˜1500 rpm and ESP-on, minimum inter-vehicle distance=19 m, average angular speed=81 rad/sec, and lane change frequency: slightly higher than normal.

When the propensity for driving of external data selected by a user is dynamic, the driving control-related data of the external data may be average speed=55 km/h, maximum speed=120 km/h, deceleration/acceleration control of 1500˜2000 rpm and ESP-on, minimum inter-vehicle distance=15 m, average angular speed=85 rad/sec, and lane change frequency: high. When the propensity for driving of the external data is reflected to the control value to which the propensity for driving a user has been reflected, the driving control-related data may be average speed=48.75 km/h, maximum speed=106.25 km/h, deceleration/acceleration control of 1000˜2000 rpm and ESP-on, minimum inter-vehicle distance=17 m, average angular speed=83 rad/sec, and lane change frequency: high.

Referring to FIG. 13, the real-time sensing-based control range (safety range) in the current section in autonomous driving may be defined to be average speed 30˜55 km/h, maximum speed 80˜110 km/h, deceleration/acceleration control of 1000˜2500 rpm and ESP-on, minimum inter-vehicle distance=15˜30 m, average angular speed=˜90 rad/sec, lane change frequency: slightly higher than normal, etc.

An example with average speed=40 km/h, maximum speed=90 km/h, deceleration/acceleration control of 1000˜1500 rpm and ESP-on, minimum inter-vehicle distance=20 m, average angular speed=80 rad/sec, and lane change frequency: normal is assumed as driving control-related data according to a vehicle control situation in the current section.

When the propensity for driving of external data selected by a user is dynamic, the driving control-related data of the external data may be average speed=55 km/h, maximum speed=120 km/h, deceleration/acceleration control of 1500˜2000 rpm and ESP-off, minimum inter-vehicle distance=10 m, average angular speed=90 rad/sec, and lane change frequency: high. Here, the maximum speed and the minimum inter-vehicle distance may exceed the real-time sensing-based control range in the current section, whereby it may deteriorate driving safety. In this case, when the autonomous module 260 applies external data to vehicle control in autonomous driving, the autonomous module 260 changes the maximum speed and the minimum inter-vehicle distance to the maximum value of the real-time sensing-based control range. For example, the autonomous module 260 can adjust the propensity for driving (Dynamic) of the external data selected by the user in autonomous driving such that the driving control-related data are average speed=55 km/h, maximum speed=110 km/h (maximum value applied), deceleration/acceleration control of 1000˜2000 rpm and ESP-off, minimum inter-vehicle distance=15 m (maximum value applied), average angular speed=90 rad/sec, and lane change frequency: high.

An autonomous vehicle and a method of controlling the autonomous vehicle of the present invention may be described as follows.

The autonomous vehicle of the present invention includes: an object detection unit that measures a sensing distance using one or more of a camera, a radar, a lidar, an ultrasonic sensor, and an infrared sensor; an autonomous module that determines a real-time sensing-based control range limited within the sensing distance, and reflects one or more of a learned propensity for driving of a user and a propensity for driving defined by external data received from an external device to driving control-related data of the vehicle; and a vehicle driving unit that drives the vehicle that is driven in an autonomous mode in accordance with the driving control-related data.

The vehicle driving unit adjusts deceleration/acceleration and steering of the vehicle on the basis of the driving control-related data.

The sensing distance is a maximum sensing distance at which an object can be detected.

The driving control-related data of the vehicle include one or more of an average speed, a maximum speed, a deceleration/acceleration control level, an inter-vehicle distance, an angular speed, and a lane change frequency.

The autonomous module adjusts the driving control-related data using the average of the result of adding a value defined by the learned propensity for driving of a user to a predetermined default value or a current value. The autonomous module limits the driving control-related data to the maximum value of the control range when the driving control-related data to which the learned propensity for driving of a user has been reflected exceeds the control range.

The autonomous module adjusts the driving control-related data using the average of the result of adding a value defined by the external data to a predetermined default value or a current value. The higher the application frequency of the external data to the driving control-related data, the higher the weight that is given to the external data. The autonomous module limits the driving control-related data to the maximum value of the control range when the driving control-related data to which the external data have been reflected exceeds the control range.

The control range is changed in accordance with the sensing distance that is measured in real time while the vehicle is driven in the autonomous mode.

The external data are obtained from the propensity for driving of an expert driver that can represent a propensity for driving, or the result of learning the average of the propensities for driving of many drivers.

The method of controlling the autonomous vehicle of the present invention includes: measuring a sensing distance using one or more of a camera, a radar, a lidar, an ultrasonic sensor, and an infrared sensor; determining a real-time sensing-based control range limited within the sensing distance; reflecting one or more of a learned propensity for driving of a user and a propensity for driving defined by external data received from an external device to driving control-related data of the vehicle; and driving the vehicle that is driven in an autonomous mode in accordance with the driving control-related data.

The present invention can be achieved by computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage, and may also be implemented in a carrier wave type (for example, transmission using the internet). Accordingly, the detailed description should not be construed as being limited in all respects and should be construed as an example. The scope of the present invention should be determined by reasonable analysis of the claims and all changes within an equivalent range of the present invention is included in the scope of the present invention.

1. An autonomous vehicle comprising:
an object detection unit that measures a sensing distance using one or more of a camera, a radar, a lidar, an ultrasonic sensor, and an infrared sensor;
an autonomous module that determines a real-time sensing-based control range limited within the sensing distance, and reflects one or more of a learned propensity for driving of a user and a propensity for driving defined by external data received from an external device to driving control-related data of the vehicle; and
a vehicle driving unit that drives the vehicle that is driven in an autonomous mode in accordance with the driving control-related data.

2. The autonomous vehicle of claim 1, wherein the vehicle driving unit adjusts deceleration/acceleration and steering of the vehicle on the basis of the driving control-related data.

3. The autonomous vehicle of claim 1, wherein the sensing distance is a maximum sensing distance at which an object can be detected.

4. The autonomous vehicle of claim 1, wherein the driving control-related data of the vehicle include one or more of an average speed, a maximum speed, a deceleration/acceleration control level, an inter-vehicle distance, an angular speed, and a lane change frequency.

5. The autonomous vehicle of claim 1, wherein the autonomous module adjusts the driving control-related data using an average of a result of adding a value defined by the learned propensity for driving of a user to a predetermined default value or a current value.

6. The autonomous vehicle of claim 5, wherein the autonomous module limits the driving control-related data to a maximum value of the control range when the driving control-related data to which the learned propensity for driving of a user has been reflected exceeds the control range.

7. The autonomous vehicle of claim 1, wherein the autonomous module adjusts the driving control-related data using an average of a result of adding a value defined by the external data to a predetermined default value or a current value.

8. The autonomous vehicle of claim 7, wherein the autonomous module limits the driving control-related data to a maximum value of the control range when the driving control-related data to which the external data have been reflected exceeds the control range.

9. The autonomous vehicle of claim 8, wherein the higher the application frequency of the external data to the driving control-related data, the higher the weight that is given to the external data.

10. The autonomous vehicle of claim 9, wherein the autonomous module limits the driving control-related data to the maximum value of the control range when the driving control-related data to which the external data have been reflected exceeds the control range.

11. The autonomous vehicle of claim 1, wherein the control range is changed in accordance with the sensing distance that is measured in real time while the vehicle is driven in the autonomous mode.

12. The autonomous vehicle of claim 1, wherein the external data are obtained from a propensity for driving of an expert driver that can represent a propensity for driving, or a result of learning an average of propensities for driving of many drivers.

13. A method of controlling an autonomous, the method comprising:
measuring a sensing distance using one or more of a camera, a radar, a lidar, an ultrasonic sensor, and an infrared sensor;
determining a real-time sensing-based control range limited within the sensing distance;
reflecting one or more of a learned propensity for driving of a user and a propensity for driving defined by external data received from an external device to driving control-related data of the vehicle; and
driving the vehicle that is driven in an autonomous mode in accordance with the driving control-related data.

14. The method of claim 13, wherein the driving control-related data of the vehicle include one or more of an average speed, a maximum speed, a deceleration/acceleration control level, an inter-vehicle distance, an angular speed, and a lane change frequency.

15. The method of claim 14, further comprising adjusting the driving control-related data using an average of a result of adding a value defined by the learned propensity for driving of a user to a predetermined default value or a current value.

16. The method of claim 15, further comprising limiting the driving control-related data to a maximum value of the control range when the driving control-related data to which the learned propensity for driving of a user has been reflected exceeds the control range.

17. The method of claim 13, further comprising adjusting the driving control-related data using an average of a result of adding a value defined by the external data to a predetermined default value or a current value.

18. The method of claim 17, further comprising limiting the driving control-related data to a maximum value of the control range when the driving control-related data to which the external data have been reflected exceeds the control range.

19. The method of claim 17, further comprising increasing a weight that is given to the external data, as an application frequency of the external data to the driving control-related data is high.

20. The method of claim 19, further comprising limiting the driving control-related data to a maximum value of the control range when the driving control-related data to which the external data have been reflected exceeds the control range.
